(19) United States
(12) Patent Application Publication
(10) Pub. No.: US 2014/0124108 A1
(43) Pub. Date: May 8, 2014

(54) TYRE HAVING MULTILEVEL SONIC WEAR INDICATORS

(71) Applicant: Antoine Paturle, Clermont-Ferrand Cedex 9 (FR)

(72) Inventor: Antoine Paturle, Clermont-Ferrand Cedex 9 (FR)

(73) Assignees: MICHELIN RECHERCHE ET TECHNIQUE S.A., GRANGES-PACCOT (CH); COMPAGNIE GENERALE DES ETABLISSEMENTS MICHELIN, CLERMONT-FERRAND (FR)

(21) Appl. No.: 14/126,234

(22) PCT Filed: Jun. 15, 2012
(86) PCT No.: PCT/FR2012/051340

§ 371 Date: Jan. 16, 2014

(30) Foreign Application Priority Data
Jun. 15, 2011 (FR) 1155237

(51) Int. Cl. B60C 11/24

(52) U.S. Cl. CPC B60C 11/24
USPC 152/154.2

(57) ABSTRACT

A tyre includes two sets of acoustic (sonic) wear indicators associated with two wear thresholds. Noise is generated when each wear threshold is exceeded. Each wear indicator of each set of wear indicators is axially aligned with each other wear indicator of that set of wear indicators. A number of sets of wear indicators associated with each wear threshold is different from a number of sets of wear indicators associated with each other wear threshold. The sets of wear indicators associated with each wear threshold are evenly distributed circumferentially about the tyre. Each wear indicator is formed of a projection of rubber extending from a bottom portion of a circumferential groove of the tyre.

The invention relates to the field of vehicle tyres and how to detect the level of wear thereof.

As a tyre gradually runs along the ground, its tread that is in contact with the ground becomes worn away through friction. This wear notably causes a reduction in the depth of tread patterns formed in the tread.

For obvious safety reasons, it is important to check tyre tread wear before it becomes excessive and too significantly impairs tyre performance, notably on a road surface that is wet or covered with snow.

To make it easier to check wear and detect excessive wear, tyres are commonly equipped with visual tread wear indicators that allow the user to differentiate between several levels of wear.

One example of multilevel wear indicators commonly in use consists of three letters “DWS” (Dry-Wet-Snow) which are formed in the tread of the tyre and the depth of which corresponds to the wear threshold beyond which the tyre no longer functions as correctly and reliably under the conditions corresponding to that letter. Thus, when all three letters “DWS” are visible, the depth of the tread patterns is sufficient for all conditions of use. When the letter “S” disappears, the remaining letters “DW” indicate that the tread patterns are deep enough for most conditions of driving on wet and dry road surfaces Finally, when the letter “W” disappears, the remaining letter “D” indicates that the tread patterns are of a depth suited to conditions of driving on dry road surfaces.

One disadvantage with this type of wear indicator is that it requires the driver of the motor vehicle to be vigilant and to conduct a regular visual check of the condition of his tyres. Now, many drivers omit to carry out such checks and change their tyres too late, for example when, during compulsory testing of the vehicle, a garage mechanic checks the tyre wear.

Further, this type of wear indicator is not able to alert the driver of the vehicle until one of the wear thresholds is reached, so that the reaching of the threshold above cannot be anticipated. Thus, although they do pay attention to the tyre wear of their vehicles, many drivers drive around under driving conditions on tyres that have reached one of the wear thresholds so that the tyres are unable to provide correct and dependable operation under the conditions corresponding to that threshold.

It is a notable object of the invention to provide a tyre equipped with a type of wear indicator that is more effective and more dependable.

To this end, one subject of the invention is a tyre comprising:
at least two wear thresholds,
for each wear threshold, at least one set of at least one acoustic wear indicator associated with at least this wear threshold so as to generate an acoustic fingerprint noise at least when this threshold has been exceeded, each indicator of each set being substantially axially aligned with each other indicator of the set;
the number of set(s) of indicator(s) associated with each threshold being different from the number of set(s) of indicator(s) associated with each other threshold;
the sets of indicator(s) associated with each threshold being evenly circumferentially distributed about the tyre; and
each indicator consisting of a projection of rubber extending radially from the bottom of a circumferential groove of the tyre, the projection being designed so that it comes into contact with the ground as it passes through the contact area in which the tyre makes contact with the ground once the threshold associated with the indicator has been exceeded.

Because of the different number of set(s) of indicators associated with each threshold, the characteristics of the noise emitted by the indicators once each threshold has been exceeded are different. Thus, for a given speed, once a given threshold has been exceeded, the noise emitted by the indicators associated with this given threshold displays certain characteristics, whereas when another threshold has been exceeded, the noise emitted by the indicators associated with this other threshold displays other characteristics.

What is meant by “sets that are evenly circumferentially distributed” is that each set of indicator(s) associated with a given threshold is situated substantially at the same angular distance from the two sets of indicator(s) associated with this threshold and adjacent to it. In other words the sets of indicator(s) that are evenly distributed associated with a given threshold have the same angular separation one from the next. When just one set is associated with a given threshold, this single set is also evenly circumferentially distributed. Specifically, in this case, the adjacent sets are formed by this same set.

Further, as the sets of indicator(s) are evenly circumferentially distributed around the tread of the tyre whatever the threshold reached, the noises emitted once each threshold has been exceeded have frequency characteristics which are unique and noticeable. Specifically, spectral analysis of the noise emitted once each threshold has been exceeded reveals, in the frequency domain, a Dirac comb that can easily be identified from all the parasitic noise such as the road noise of the tyre, the wind, the engine noise or the associated drive train noise. To do that, use may be made of a wear detection method described in application PCT/FR2010/052584. As an alternative, other methods may be used.

The indicators may be axially offset from one another while at the same time being evenly circumferentially distributed about the tread.

For each indicator associated with each threshold, the acoustic fingerprint noise appears only when the tyre has been worn beyond the corresponding threshold. Each indicator associated with a threshold thus forms a wear indicator that is acoustic when said threshold has been exceeded.

In the present application, the acoustic fingerprint noise generated by the indicators is the acoustic signature of the indicators. This noise may also be considered to be the acoustic fingerprint of the indicators.

Thus, even if the driver does not regularly perform a visual inspection of the surface condition of his tyres, he will be informed of the crossing of each threshold, when, in driving, the acoustic fingerprint noise is detected.

For preference, use is made of a processing unit and one or more microphones for detecting the running noises, these being connected to the processing unit and able to discern the acoustic fingerprint noise from the running noise and inform the driver that his tyres are worn.

The indicators may be axially offset from one another while being evenly circumferentially distributed about the tread.

It will be noted that in all the embodiments and alternative forms associated therewith, the characteristics of the indicators associated with each threshold make it possible to ensure that the indicators are evenly circumferentially distributed above each threshold whatever the number of indicators associated with each threshold and whatever the axial layout thereof.

Because each acoustic wear indicator is made up of a projection of rubber it therefore differs from an acoustic cavity comprising two transverse ribs, notably from an acoustic cavity of this type such that, beyond each threshold, each acoustic cavity opens radially to the outside of the tyre and is configured so that it is closed by the ground in a substantially airtight manner as it passes through the contact area in which the tyre is in contact with the ground. Such acoustic cavities are described in the publication FR 2 937 902.

Apart from comprising the aforementioned projections of rubber, the tyre may optionally comprise wear indicators with an acoustic cavity comprising two transversal ribs delimiting the cavity, for example for another wear threshold.

However, in another embodiment, the tyre comprises no cavity delimited by two ribs which are formed transversely to the bottom of a groove, of predetermined height when the tyre is new, substantially equal to the difference between the predetermined depth of the groove and one of the predetermined wear thresholds, the distance separating the two ribs being less than a distance that is predetermined such that when one or each of the wear thresholds has been exceeded, the cavity formed by the groove and the two ribs becomes an acoustic cavity.

In one embodiment, each set comprises a single indicator.

In another embodiment, each set comprises at least two indicators.

In this embodiment, an indicator of a set associated with a threshold has substantially the same azimuth position as that of another indicator of the set associated with the same threshold. Thus, these indicators create sound simultaneously.

In another embodiment, two axially aligned indicators are associated with two different thresholds. In that case, the two indicators do not form part of the same set.

Surprisingly, the inventors of the invention have discovered that the projections are enough to give rise to a characteristic noise when the tyre is running after the wear threshold has been exceeded. The inventors are putting forward the hypothesis whereby this noise is generated by at least two distinct physical phenomena which have a synergistic effect. On the one hand, once the wear threshold has been reached, the noise is generated by impact of the projection with the ground. On the other hand, once the wear threshold is reached, as the tyre runs along the ground, an air plug is likely to be formed in the groove ahead of the projection because of the high relative speed between the tyre and the air through which the tyre is moving. Air is therefore temporarily trapped in a space confined between this plug and the projection as this space passes through the contact area in which the tyre is in contact with the ground. Under the effect of the deformation of the tyre in the contact area, this air trapped in this space is compressed and suddenly expands as it leaves the contact area when the tread breaks contact with the ground at the rear of the tyre.

Because each wear indicator consists of a single projection rather than of two projections forming a cavity closed to air as it passes through the contact area in which the tyre is in contact with the ground, for the same number of wear indicators, the number of projections arranged in the groove or grooves is halved. The potential loss of performance generated by the projections is thus limited. There is therefore relatively little impact on the grip performance of the tyre.

Because the projections are arranged in the grooves, the noise emitted as a result of the projections is amplified by comparison with acoustic wear indicators positioned elsewhere in the tread. The emitted noise is amplified by a flared resonator formed by the tyre and the ground once the acoustic wear indicator has passed through the contact area. This amplification through a flared resonator effect is at a maximum when the projections are preferably arranged axially in a central part of the tread. The central part of the tread means the region in the tread that extends axially, i.e. parallel to the axis of rotation of the tyre, over approximately half the width of this tread under nominal load and pressure conditions and that is centered relative to the central median plane of the tyre.

The rubber projections may, transversally, extend over just part of the width of a circumferential groove. In this case, there is better removal of the water contained in a circumferential groove in the case of rain.

However, it has been found that the acoustic effect generated by a rubber projection is notably greater when this rubber projection extends transversally across the entire width of a circumferential groove. When this rubber projection comes into contact with the ground (the tyre being worn at least down to the corresponding wear threshold level), the circumferential groove becomes closed by the ground at the rubber projection, which delimits a space upstream and a space downstream of this groove, without communication between them at the rubber projection. It will be appreciated that this advantageously notably increases the acoustic effect.

The circumferential width of a rubber projection is generally between 2 and 15 mm (millimetres) and preferably comprises between 3 and 10 mm. These values are suitable for generating sufficient road noise. The circumferential position of a projection may be considered from the median circumferential position of the projection in contact with the ground, from the relevant threshold onwards.

For preference, the projections are arranged in such a way that regardless of the degree of wear of the tyre, two circumferentially successive projections of one and the same groove and the groove delimit a space that is open to the air as the two projections pass through the contact area in which the tyre is in contact with the ground.

As an option, when the tyre is new, each circumferential groove has a predetermined depth and the height of each projection of each indicator is substantially equal to the difference between the predetermined depth of the groove and the threshold associated with the indicator.

A rubber projection may be solid, namely have no cavity.

Optionally, each projection comprises at least one cavity formed in the projection, the cavity being shaped in such a way that, when the threshold associated with the indicator comprising the projection has been exceeded, the cavity:
opens radially to the outside of the tyre, and
is closed by the ground in a substantially airtight manner as it passes through the contact area in which the tyre is in contact with the ground.

Such a cavity typically does not extend as far as the bottom of the circumferential groove. Its volume is typically notably less than 250 mm³ (millimetres cubed), for example less than 150 mm³.

Such a cavity is, however, an acoustic cavity. The noise it generates, although limited, adds to the noise generated by the grooves and yields a noise that is amplified by comparison with a projection that has no cavity.

Further, the cavity allows the first threshold projection to be distinguished visually from the minimum tread depth indicator.

Finally, such a cavity does not penalize tyre performance or make it more complicated to design.

In one embodiment, each projection of each indicator associated with a threshold is circumferentially separated from each projection of each indicator associated with each other threshold.

In another embodiment, each projection of each indicator associated with a threshold is immediately adjacent to a projection of an indicator associated with another threshold, which has the advantage that these two projections do not between them define a closed cavity likely to disturb detection of the expected noise.

Furthermore, the number of locations for the first threshold and second threshold projections is reduced. The wear indicators therefore have little if any impact on the grip performance of the tyre.

In one embodiment, at least one projection has a cross section for contact with the ground that varies as a function of the degree of wear of the tyre.

Thus, the contact surface area for contact between the projection and the ground can be varied thus varying the volume of the noise produced by the projection.

For preference, the contact cross section increases with the degree of wear of the tyre.

In another embodiment, at least one projection has a contact cross section for contact with the ground that is constant as a function of the degree of wear of the tyre.

In an embodiment referred to as having a “descending” acoustic pattern, the numbers NEᵢ, NEᵢ₊₁ of sets of indicators, associated respectively with two consecutive thresholds Si, Sᵢ₊₁ satisfy NEᵢ<NEᵢ₊₁, the threshold Sᵢ₊₁ being higher than the threshold Sᵢ.

In other words, the number NEᵢ of sets of indicators increases with the wear of the tyre.

In this embodiment, by increasing the number of sets and therefore the number of indicators, it is found that the noise emitted by the indicators then becomes increasingly easy to detect as the tyre gradually wears.

In an alternative form of this embodiment, kᵢ=NEᵢ₊₁/NEᵢ>1 for any value of i ε [1, M] where M is the total number of thresholds and kᵢ is a natural integer. That makes it possible to minimize the number of indicators that appear at each threshold. Thus, the effect that the indicators have on tyre performance, notably hydrodynamic performance, is minimized. Thus, each indicator associated with a given threshold is also associated with all the thresholds above the given threshold. This feature obviously does not apply to the indicators associated only with the highest threshold.

In another alternative form, the indicator or indicators associated with a given threshold comprise some of the indicators associated with the threshold below the given threshold and the indicators that have appeared beyond the given threshold. Thus, only a few indicators associated with the lower threshold are also indicators associated with the given threshold. This may notably correspond to the case of immediately adjacent projections:

When a projection corresponding to a determined wear threshold is not immediately adjacent to another projection it typically also constitutes a wear indicator associated with any higher wear threshold. By contrast, in cases where a projection is immediately adjacent to another projection corresponding to a higher wear threshold, when the latter wear threshold is reached the two immediately adjacent projections then form just one single projection, therefore acting as a single wear indicator corresponding to that threshold (rather than two juxtaposed indicators).

As a result, the number of wear indicators associated with a threshold needs to be analysed according to the number of distinct projections in contact with the ground from this threshold onwards.

The number of sets of acoustic wear indicators corresponding to a determined wear threshold is generally between 2 and 30.

It is preferably at most 10 and highly preferably 8 to 10 sets for a passenger vehicle. It is generally 22 at most and preferably 12 to 20 sets for a utility heavy goods vehicle.

The invention will be better understood from reading the description which will follow, which is given solely by way of nonlimiting example and made with reference to the drawings in which:

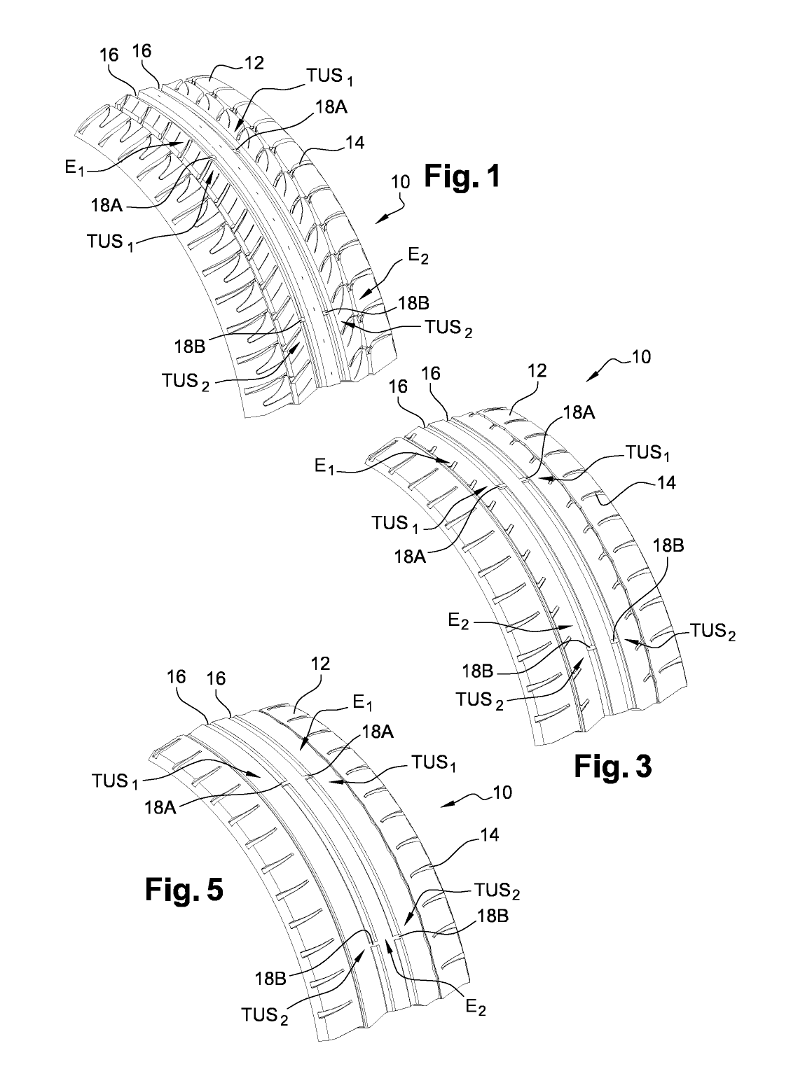

FIG. 1 is a perspective view of a new tyre tread with a “descending” acoustic pattern according to a first embodiment;

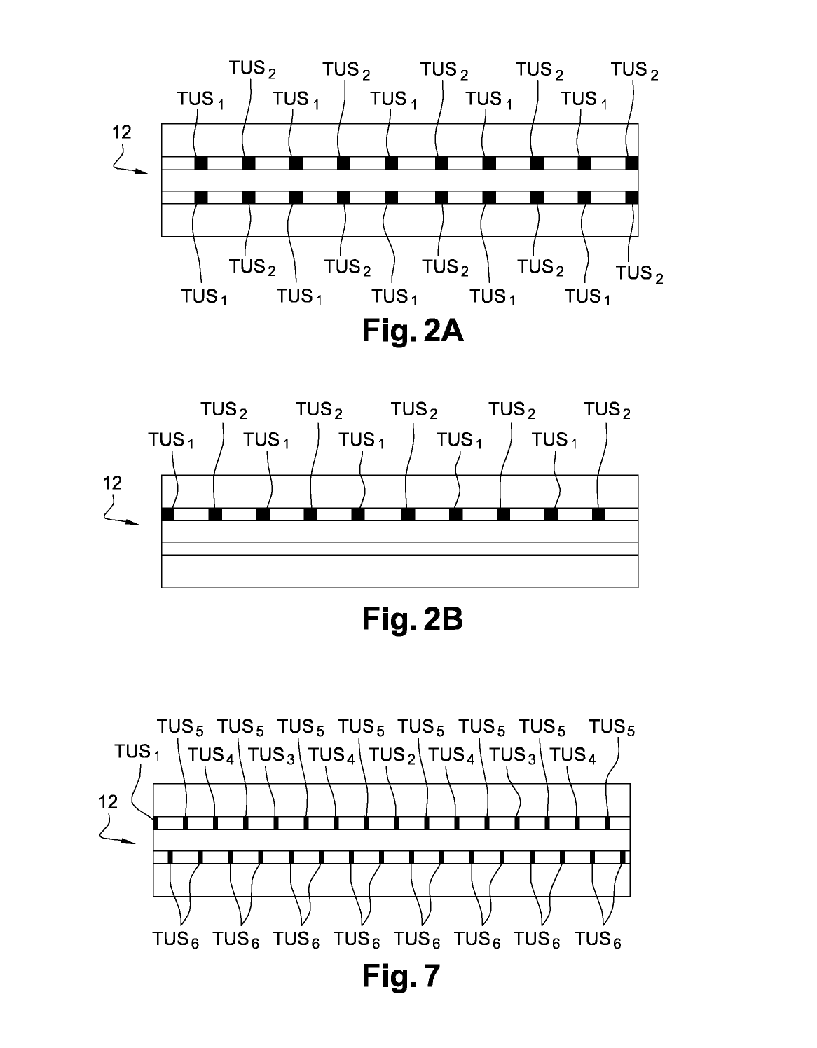

FIG. 2A schematically illustrates a developed tread of the tyre of FIG. 1;

FIG. 2B is a view analogous to that of FIG. 2A of an alternative form of the tyre of FIG. 1;

FIG. 3 is a perspective view of the tread of the tyre depicted in FIG. 1, worn beyond a first wear threshold;

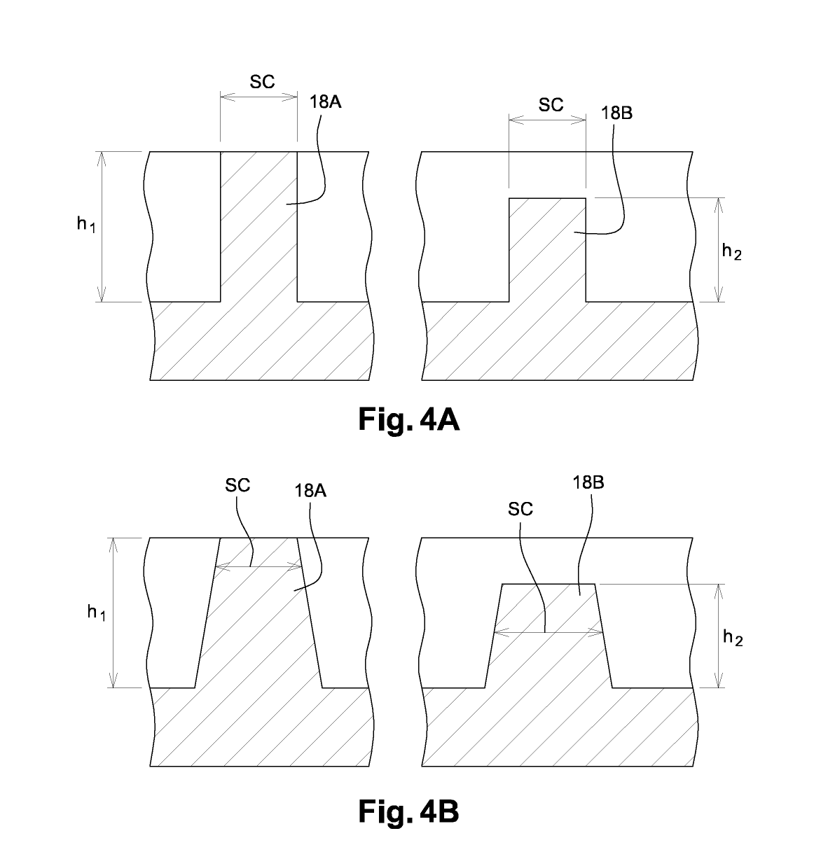

FIG. 4A is a view in axial section on a plane passing through a groove of the tread of the tyre of FIG. 3;

FIG. 4B is a view analogous to that of FIG. 4A of an alternative form of the tyre of FIG. 3;

FIG. 5 is a perspective view of the tread of the tyre depicted in FIG. 1, worn beyond a second wear threshold;

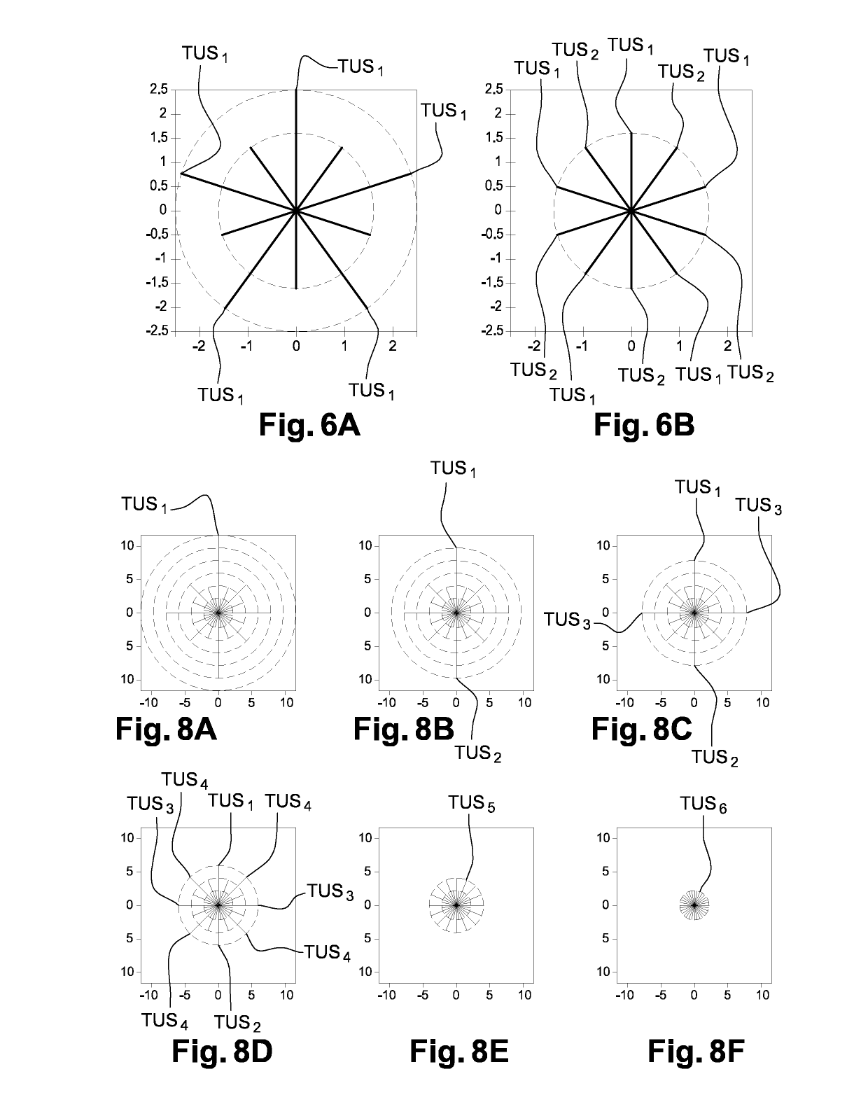

FIGS. 6A and 6B schematically illustrate the distribution of the sets of acoustic cavities of the tyre of FIG. 1;

FIG. 7 schematically illustrates a developed tread of a tyre with a “descending” acoustic pattern according to a second embodiment;

FIGS. 8A to 8F schematically illustrate the distribution of the sets of acoustic cavities of the tyre of FIG. 7;

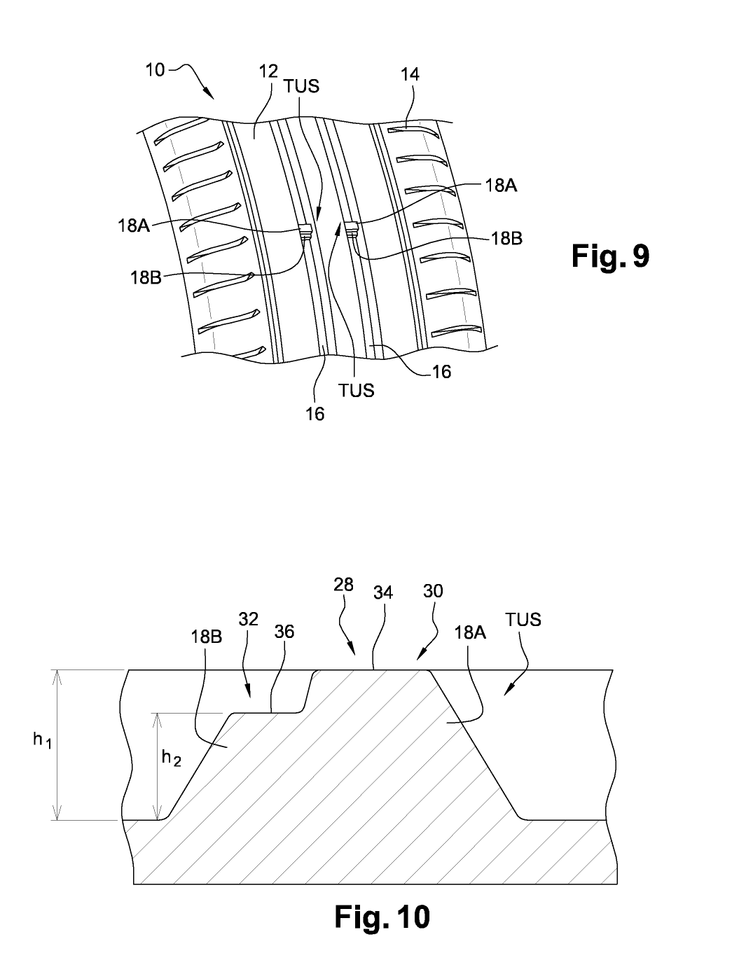

FIG. 9 is a view analogous to that of FIG. 1 of a new tyre according to a third embodiment of the invention;

FIG. 10 is a view in axial section in a plane passing through a groove of a tread of the tyre of FIG. 9 which has been worn down to a first wear threshold;

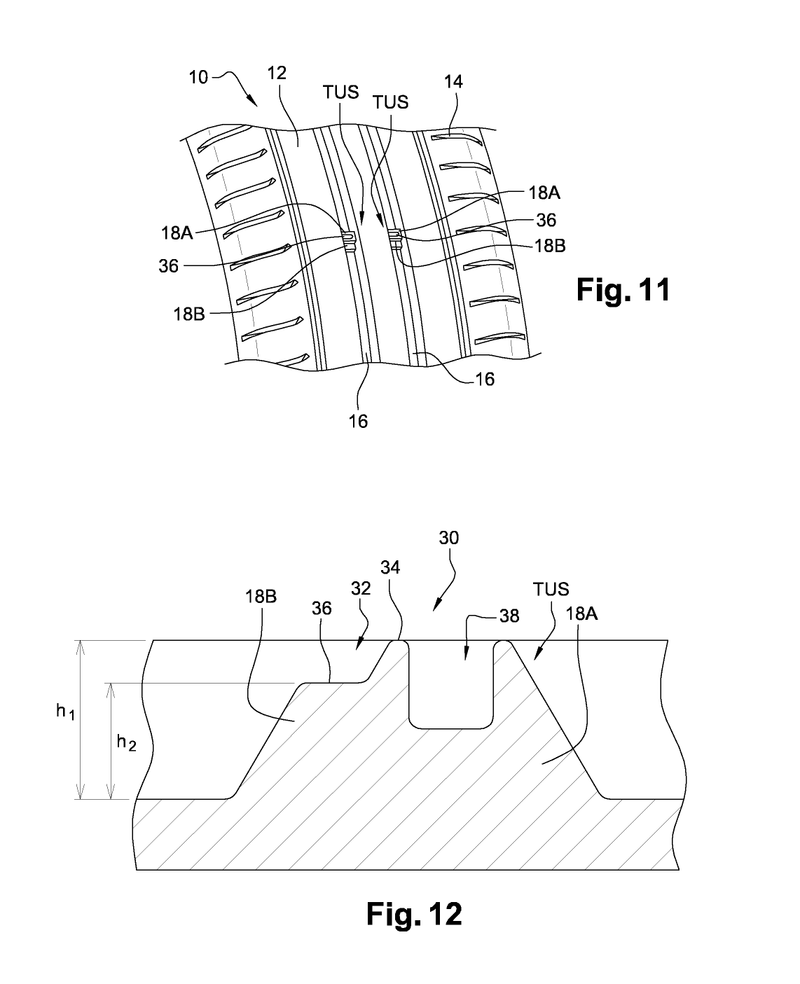

FIG. 11 is a view analogous to that of FIG. 1 of a new tyre according to a fourth embodiment of the invention;

FIG. 12 is a view in axial section of a plane passing through a groove of a tread of the tyre of FIG. 11 worn down to a first wear threshold.

FIG. 1 depicts a tyre according to a first embodiment of the invention, denoted by the general reference 10. The tyre 10 is intended for a passenger vehicle. The tyre 10 is substantially of revolution about an axis.

The tyre 10 comprises a tread 12 of substantially toroidal shape, the external surface of which has tread patterns 14. In particular, the tread 12 comprises two circumferential and parallel grooves 16 cut into the surface of the tyre, having a predetermined depth H when the tyre 10 is new. The depth H of these grooves 16 is of the order of 8 mm and their width of 10 mm. The tyre 10 comprises visual wear indicators (not illustrated) indicating the minimum legal tread depth threshold SL for the tyre. The depth of each groove corresponding to the threshold SL is fixed at 1.6 mm, which corresponds to a threshold SL=6.4 mm. The tyre 10 comprises sets E1, E2 of acoustic wear indicators TUS. Each indicator TUS consists of a rubber projection 18 extending radially from the bottom of one of the grooves 16.

The tyre 10 comprises two type of indicator TUS, denoted TUS1, TUS2 each one associated respectively with at least one predetermined radial wear threshold S1, S2 for the tyre so as to generate an acoustic fingerprint noise at least when one of the thresholds S1, S2 have been exceeded. In this particular instance, each indicator TUS1 associated with the threshold S1 is also associated with the threshold S2 so as to generate an acoustic fingerprint noise when the two thresholds S1, S2 have been exceeded. Each indicator TUS2 is associated only with the threshold S2 so as to generate an acoustic fingerprint noise when only the threshold S2 has been exceeded.

Each indicator TUS1, TUS2 consists respectively of a projection 18A, 18B also associated with at least one predetermined wear threshold S1, S2 of the tyre. Each projection 18A, 18B has respectively a first and a second predetermined height h₁, h₂ when the tyre is new. h₁>h₂ and S₂>S₁ so that each projection 18A is associated with the thresholds S₁ and S₂ and each projection 18B is associated only with the threshold S₂.

The tyre 10 comprises no cavity delimited by two ribs which are formed transversely to the bottom of a groove, of predetermined height when the tyre is new, substantially equal to the difference between the predetermined depth of the groove and one of the predetermined wear thresholds, the distance separating the two ribs being less than a distance that is predetermined such that when one or each of the wear thresholds has been exceeded, the cavity formed by the groove and the two ribs becomes an acoustic cavity.

The threshold S₂ is reached after the threshold S₁. In other words, the threshold S₂ represents more advanced wear than the threshold S₁. The threshold S₂ is reached when the tyre wear is greater than the wear at which the threshold S₁ is reached. The first threshold S₁ corresponds substantially to 90% of the threshold SL, i.e. h₁=2.5 mm and S₁=5.5 mm. The second threshold S₂ corresponds substantially to 100% of the threshold SL, i.e. h₂=1.6 mm and S₂=6.4 mm.

Thus, in this embodiment, the first threshold S₁ corresponds to wear beyond which the tyre displays performance that could be impaired on a wet road surface. The second threshold S₂ itself corresponds to wear beyond which the tyre no longer meets the legal requirements.

FIGS. 6A-6B schematically indicate the indicators TUS₁, TUS₂ using lines. These lines run radially over a radial portion which schematically indicate the thresholds between which the corresponding indicators TUS₁, TUS₂ are acoustic.

The thresholds S₁, S₂ are depicted schematically in FIGS. 6A-6B.

FIG. 6A depicts the tyre 10 when it has reached the first wear threshold S₁ but has not yet reached the second wear threshold S₂. FIG. 6B depicts the tyre 10 when it has reached the second wear threshold S₂.

When the tyre is new, as indicated in FIG. 1, the height of the projections 18A, 18B is smaller than the depth of the grooves 16 so that each indicator TUS₁, TUS₂ has a space on top of the projections 18A, 18B, i.e. at the top of the projections 18A, 18B. Thus, even when the tread is contact with flat smooth ground, the ground does not come into contact with the projections 18A, 18B.

FIG. 2A depicts a development diagram of the tread of the tyre of FIG. 1.

Each set E₁ of indicators TUS₁ comprises two projections 18A and each set E₂ of indicators TUS₂ comprises two projections 18B. Each projection 18A, 18B respectively of each set E₁ , E₂ is substantially axially aligned with a respective one of each other projection 18A, 18B of the same set E₁, E₂ respectively.

The respective sets E₁-E₂ of indicators TUS₁-TUS₂ associated with each respective threshold S₁, S₂, in this instance the projections 18A-18B, are evenly circumferentially distributed about the tyre 10. Thus, on the one hand, the sets of projections 18A are evenly circumferentially distributed about the tyre 10 and, on the other hand, the sets of projections 18B are evenly circumferentially distributed about the tyre 10.

Moreover, all the sets of projections 18 are evenly circumferentially distributed about the tyre 10. Thus, beyond each corresponding threshold S₁, S₂, as the tyre rotates, the projections 18A, 18B come at constant time intervals into contact with the ground when the tyre is running at substantially constant speed.

The tyre 10 comprises NE₁=5 sets E₁ of two indicators TUS₁ and NE₂=10 sets E₂ of two indicators TUS₁, TUS₂. Thus, the number of sets of indicators associated with each threshold is different from the number of sets of indicators associated with each other threshold.

FIG. 2B depicts a development diagram of an alternative form of the tread of FIG. 2A.

Unlike the tread of FIG. 2A, the tyre 10 comprises NE₁=5 sets E₁ of just one indicator TUS₁ and NE₂=10 sets E₂ of just one indicator TUS₁, TUS₂. Further, all the indicators TUS₁, TUS₂ are arranged in the same groove 16.

FIG. 3 depicts the tyre 10 of FIG. 1 when it is worn beyond the threshold S₁. In other words, this is a tyre which has run a great many kilometres and the tread 12 of which has progressively been worn down until it has lost a few millimetres. This tyre 10 is also depicted schematically in FIG. 6A which shows that, beyond the threshold S₁, the tyre 10 has NE₁=5 sets of two indicators TUS₁.

In this particular instance, the wear of the tread 12 of the tyre 10 as indicated in FIG. 2 is 6 mm, i.e. beyond the threshold S₁, or in other words greater than the distance which, when the tyre 10 is new, separates the top of the projections 18A from the surface of the tread 12. Bearing in mind the wear in excess of S₁, the top of the projections 18A is now at the same level as the surface of the tread 12.

Tyre wear is below the threshold S₂, or in other words less than the distance which, when the tyre 10 is new, separates the top of the projections 18B from the surface of the tread 12. The top of the projections 18B is at a lower level than the tread at this stage of wear.

Beyond the threshold S₁, each projection 18A has a depth less than the height h₁. Here, the depth is less than 2.5 mm and measures 2 mm for a wear of 6 mm. The height of each projection 18A is therefore equal to its depth. This height or depth is equal to the difference between the depth of each groove 16 and the wear of the tyre 10.

Each projection 18A is arranged so that it comes into contact with the ground as it passes through the contact area in which the tyre is in contact with the ground once the threshold S₁ has been exceeded.

FIG. 4A depicts a view in axial section on a plane passing through a groove of the tread of the tyre of FIG. 3.

FIG. 4A depicts two projections 18A, 18B having a cross section SC for contact with the ground. The cross section SC is the cross section of the projection in a plane perpendicular to the radial direction of the tyre 10. In this particular instance, the cross sections SC of the projections 18A, 18B are equal and constant as a function of the wear of the tyre 10, i.e. regardless of the level of wear of the tyre 10.

FIG. 4B depicts an alternative form of the projections of FIG. 4A.

Unlike the projections of FIG. 4A, the projections 18A, 18B have a contact cross section SC for contact with the ground that can vary as a function of the wear of the tyre 10. In this particular instance, the contact cross section SC increases with the degree of wear of the tyre 10.

FIG. 5 depicts the tyre 10 of FIGS. 1 and 2 when it has been worn beyond the threshold S₂. This tyre 10 is also schematically depicted in FIG. 6B which shows that the tyre 10 comprises NE₂=10 sets of two indicators TUS₁, TUS₂.

In this particular instance, the wear of the tread 12 of the tyre 10 indicated in FIG. 5 is 7 mm, i.e. greater than the threshold S₂, but also greater than the threshold S₁, or in other words greater than the distance which, when the tyre 10 is new, separates the top of the projections 18B from the surface of the tread 12. Given the wear in excess of S₂, the top of the projections 18B, and also that of the projections 18A, are at the same level as the surface of the tread 12.

Once the threshold S₂, has been exceeded, each projection 18B has a depth less than the height h₂. Here, the depth is less than 1.6 mm and measures 1 mm for a wear of 7 mm. The height of each projection 18A, 18B is therefore equal to its depth. This height or depth is equal to the difference between the depth of each groove 16 and the wear of the tyre 10.

Each groove 18A, 18B is arranged so that it comes into contact with the ground as it passes through the contact area in which the tyre is in contact with the ground when the threshold S₂ has been exceeded.

The indicators TUS₁, TUS₂ are arranged so as to generate acoustic fingerprint noises respectively above the thresholds S₁, S₂ and are qualified as “acoustic” indicators. In the example illustrated, the numbers NEᵢ, NEᵢ₋₁ of sets of indicators associated respectively with two consecutive thresholds Sᵢ, Sᵢ₋₁ satisfy NEᵢ₋₁<NEᵢ for i ε [2, M] where M is the total number of wear thresholds and the threshold Sᵢ is higher than the threshold Sᵢ₊₁. Therefore, for each value of i ε [2, M], kᵢ=NEᵢ/NEᵢ₋₁ because NEᵢ/NEᵢ₋₁>1. This then is what qualifies a tyre in which NE₂>NE₁, as a tyre which has a “descending” acoustic pattern. In this embodiment, k₁=NE₂/NE₁=2.

FIGS. 7 and 8A-8F depict a tyre according to a second embodiment. The tyre 10 is intended for a vehicle of the heavy goods vehicle type. Elements analogous to those denoted in the preceding figures are denoted by identical references.

FIG. 7 depicts a development diagram of the tread 12 of the tyre 10 according to the second embodiment of the invention.

Each set E₁-E₆ comprises a single acoustic wear indicator TUS₁-TUS₆ consisting of a projection 18A-18F.

Unlike in the first embodiment, the tyre 10 according to the second embodiment comprises six wear thresholds S₁-S₆ with NE₁=1, NE₂=2, NE₃=4, NE₄=8, NE₅=16 and NE₆=32 and therefore the following kᵢ ratios: K₁=k₂=k₃=k₄=k₅=k₆=NE₂/NE₁=NE₃/NE₂=NE₄/NE₃=NE₅/NE₄=NE₆/NE₅=2. As in the first embodiment, the tyre 10 has a “descending” acoustic pattern. Thus, the number of sets of indicators associated with each threshold is different from the number of sets of indicators associated with each other threshold.

The depth of the grooves 16 is of the order of 14 millimetres, in this case 14.3 mm. The depth of each groove corresponding to the threshold SL is set at 2 mm, which corresponds to a threshold SL=12.3 mm.

The tyre 10 comprises sets E₃, E₄, E₅, E₆ of four other types of indicator TUS, denoted TUS₃, TUS₄, TUS₆, TUS₆ each one respectively corresponding to a predetermined wear threshold S₁, S₂, S₃, S₄ for the tyre 10. Each indicator TUS₃, TUS₄, TUS₆, TUS₆ is respectively made of a projection 18C-18F.

Each indicator TUS₁ associated with the threshold S₁ is also associated with the thresholds S₂-S₆ so as to generate an acoustic fingerprint noise when the thresholds S₂-S₆, have been exceeded, each indicator TUS₂ is associated with the thresholds S₂-S₆ so as to generate an acoustic fingerprint noise when the thresholds S₂-S₆, have been exceeded, each indicator TUS₃ is associated with the thresholds S₃-S₆ so as to generate an acoustic fingerprint noise when the thresholds S₃-S₆, have been exceeded, each indicator TUS₄ is associated with the thresholds S₄-S₆ so as to generate an acoustic fingerprint noise when the thresholds S₄-S₆, have been exceeded, each indicator TUS₆ is associated with the thresholds S₅ et S₆ so as to generate an acoustic fingerprint noise when the thresholds S₅ and S₆ have been exceeded and each indicator TUS₆ is associated only with the threshold S₆ so as to generate an acoustic fingerprint noise only when the threshold S₆ has been exceeded.

Each projection 18C-18F respectively has a height h₃, h₄, h₅ and h₆ which is predetermined when the tyre is new. h₁>h₂>h₃>h₄>h₆>h₆ and S₆>S₆>S₄>S₃>S₂>S₁ so that each projection of type 18A is associated with the thresholds S₁-S₆, each projection of type 18B is associated with the thresholds S₂-S₆, each projection of type 18C is associated with the thresholds S₃-S₆, each projection 18D is associated with the thresholds S₄-S₆, each projection 18E is associated with the thresholds S₅ and S₆ and each projection 18F is associated only with the threshold S₆. The first threshold S₁ corresponds more or less to 19% of the threshold SL, namely h₁=12 mm and S₁=2.3 mm. The second threshold S₂ corresponds substantially to 35% of the threshold SL, i.e. h₂=10 mm and S₂=4.3 mm. The third threshold S₃ corresponds substantially to 51% of the threshold SL, namely h₃=8 mm and S₃=6.3 mm. The fourth threshold S₄ corresponds substantially to 67% of the threshold SL, namely h₄=6 mm and S₄=8.3 m. The fifth threshold S₅ corresponds substantially to 84% of the threshold SL, namely h₅=4 mm and S₅=10.3 mm. The sixth threshold S₆ corresponds more or less to 100% of the threshold SL, namely h₆=2 mm and S₆=12.3 mm.

The various thresholds correspond to various stages in the life of the tyre and during which various actions need to be undertaken in order to spread the wear across the entire tread and thus lengthen the useful life of the tyre. Thus the threshold S₂ corresponds to wear for which the tyre can be swapped on the same axle. The threshold S₄ corresponds to wear for which the tyre can be turned around. The threshold S₅ corresponds to wear for which the tyre can be regrooved to restore its performance, notably its water drainage performance.

Just as in the first embodiment, the sets E₁-E₆ of indicators TUS₁-TUS₆ associated respectively with each threshold S₁-S₆, in this instance the projections 18A-18F, are evenly circumferentially distributed about the tyre 10. Further, all the sets E₁-E₆ are evenly distributed.

FIGS. 9 and 10 depict a tyre according to a third embodiment of the invention. Elements analogous to those depicted in the preceding figures are denoted by identical references.

Unlike the tyres according to the preceding embodiments, each projection 18A of each indicator TUS₁ is immediately adjacent to a projection 18B of an indicator TUS₂.

With reference to FIG. 10 which depicts the tyre according to the third embodiment with wear corresponding to the threshold S₁, the two indicators TUS₁ and TUS₂ therefore form a single wear indicator TUS made up of a rubber projection 28 arranged at the bottom of the groove 16. The rubber projection 28 has a staircase overall shape and comprises first and second rubber parts 30, 32 respectively forming the projections 18A, 18B. Each first and second part 30, 32 respectively has a radially external surface 34, 36 intended to come into contact with the ground as the corresponding projection 18A, 18B passes through the contact area in which the tyre 10 is contact with the ground. The radial dimension of the surface 34 is greater than the radial dimension of the surface 36. In other words, the height h₁ of the first part 30 is greater than the height h₂ of the second part 32.

FIGS. 11 and 12 depict a tyre according to a fourth embodiment of the invention. Elements analogous to those depicted in the preceding figures are denoted by identical references.

Unlike the tyre according to the third embodiment, each projection 18A comprises a small acoustic cavity 38 formed in the projection 18A. In this particular instance, the cavity 38 is formed in the second part 32 of the wear indicator TUS.

Beyond the threshold S₁ and, preferably, also beyond the threshold S₂, the acoustic cavity 38 is configured in such a way as to open radially to the outside of the tyre 10 and so as to be closed by the ground in a substantially airtight manner as it passes through the contact area in which the tyre 10 is contact with the ground.

The invention is not limited to the embodiments described above.

The tread may comprise more than two grooves and therefore sets of indicators comprising more than two indicators that are substantially axially aligned, i.e. have the same azimuth position.

The tread may comprise several grooves and each indicator may comprise a single projection so that two circumferentially successive indicators are situated in two different grooves.

The tread may comprise indicators arranged in each groove. Thus two indicators that are more or less axially aligned in pairs may have one single threshold in common or several.

In any event, the projections may have a variable or a constant contact cross section.

It is also possible to form a cavity in the projections other than those of the indicators TUS₁ associated with the threshold S₁.

The features of the various embodiments described hereinabove may be combined provided that they are compatible with one another.

By way of additional examples of tyres with descending acoustic patterns, use may be made of tyres having three or four thresholds with the following characteristics:
NE₁=1, NE₂=2, NE₃=4, NE₄=8.
NE₁=1, NE₂=3, NE₃=6.
NE₁=1, NE₂=2, NE₃=6
NE₁=2, NE₂=4, NE₃=8.
NE₁=2, NE₂=6, NE₃=12.
NE₁=3, NE₂=6, NE₃=12.

1-15. (canceled)

16. A tyre, comprising:
at least two wear thresholds; and
for each wear threshold, at least one set of at least one acoustic wear indicator associated with at least that wear threshold, the at least one set of the least one acoustic wear indicator being structured to generate an acoustic fingerprint noise at least when that wear threshold has been exceeded, each wear indicator of each set being aligned substantially axially with each other wear indicator of that set,
wherein a number of set(s) of wear indicator(s) associated with each wear threshold is different from a number of set(s) of wear indicator(s) associated with each other wear threshold,
wherein the set(s) of wear indicator(s) associated with each wear threshold are evenly distributed circumferentially about the tyre, and
wherein each wear indicator consists in a projection of rubber that extends radially from a bottom portion of a circumferential groove of the tyre, the projection being structured to come into contact with a ground surface as the projection passes through a contact area in which the tyre makes contact with the ground surface after a wear threshold associated with that wear indicator has been exceeded.

17. The tyre according to claim 16, wherein each set includes a single wear indicator.

18. The tyre according to claim 16, wherein each set includes at least two wear indicators.

19. The tyre according to claim 16, wherein no cavity of the tyre is delimited by two ribs that are formed transversely to a bottom portion of a groove, of predetermined height when the tyre is new, substantially equal to a difference between a predetermined depth of the groove and one of the at least two wear thresholds, in which a distance separating the two ribs is less than a distance that is predetermined such that, when one or each of the at least two wear thresholds has been exceeded, a cavity formed by the groove and the two ribs becomes an acoustic cavity.

20. The tyre according to claim 19, wherein the projections are arranged such that, regardless of a degree of wear of the tyre, two circumferentially successive projections of a groove and the groove itself delimit a space that is open to air as the two projections pass through the contact area in which the tyre makes contact with the ground surface.

21. The tyre according to claim 19, wherein, when the tyre is new, each circumferential groove has a predetermined depth, and a height of each projection of each wear indicator is substantially equal to a difference between the predetermined depth of the groove and the wear threshold associated with that wear indicator.

22. The tyre according to claim 20, wherein, when the tyre is new, each circumferential groove has a predetermined depth, and a height of each projection of each wear indicator is substantially equal to a difference between the predetermined depth of the groove and the wear threshold associated with that wear indicator.

23. The tyre according to claim 19, wherein each projection includes at least one cavity formed therein, the at least one cavity being shaped in such a way that, when a wear threshold associated with a wear indicator corresponding to the projection has been exceeded:
the cavity becomes an open cavity that opens radially to outside of the tyre, and
the open cavity is closed by the ground surface in substantially an airtight manner as the open cavity passes through the contact area in which the tyre makes contact with the ground surface.

24. The tyre according to claim 19, wherein each projection of each wear indicator associated with a wear threshold is circumferentially separated from each projection of each wear indicator associated with each other wear threshold.

25. The tyre according to claim 20, wherein each projection of each wear indicator associated with a wear threshold is circumferentially separated from each projection of each wear indicator associated with each other wear threshold.

26. The tyre according to claim 19, wherein each projection of each wear indicator associated with a wear threshold is immediately adjacent to a projection of a wear indicator associated with another wear threshold.

27. The tyre according to claim 20, wherein each projection of each wear indicator associated with a wear threshold is immediately adjacent to a projection of a wear indicator associated with another wear threshold.

28. The tyre according to claim 19, wherein at least one projection has a cross section that varies as a function of wear of the tyre, the cross section being structured to make contact with the ground surface.

29. The tyre according to claim 20, wherein at least one projection has a cross section that varies as a function of wear of the tyre, the cross section being structured to make contact with the ground surface.

30. The tyre according to claim 28, wherein the cross section has an area that increases with a degree of wear of the tyre.

31. The tyre according to claim 29, wherein the cross section has an area that increases with a degree of wear of the tyre.

32. The tyre according to claim 19, wherein at least one projection has a cross section that is constant as a function of a degree of wear of the tyre, the cross section being structured to make contact with the ground surface.

33. The tyre according to claim 20, wherein at least one projection has a cross section that is constant as a function of a degree of wear of the tyre, the cross section being structured to make contact with the ground surface.

34. The tyre according to claim 16, wherein first and second sets (NEᵢ, NEᵢ₊₁) of one or more wear indicator(s) associated respectively with first and second consecutive wear thresholds (Sᵢ, Sᵢ₊₁) satisfy NEᵢ<NEᵢ₊₁, with the wear threshold Sᵢ₊₁ being higher than the wear threshold Sᵢ.

35. The tyre according to claim 17, wherein first and second sets (NEᵢ, NEᵢ₊₁) of one or more wear indicator(s) associated respectively with first and second consecutive wear thresholds (Sᵢ, Sᵢ₊₁) satisfy NEᵢ<NEᵢ₊₁, with the wear threshold Sᵢ₊₁ being higher than the wear cthreshold Sᵢ.

36. The tyre according to claim 18, wherein first and second sets (NEᵢ, NEᵢ₊₁) of one or more wear indicator(s) associated respectively with first and second consecutive wear thresholds (Sᵢ, Sᵢ₊₁) satisfy NEᵢ<NEᵢ₊₁, with the wear threshold Sᵢ₊₁ being higher than the wear threshold Sᵢ.

37. The tyre according to claim 19, wherein first and second sets (NEᵢ, NEᵢ₊₁) of one or more wear indicator(s) associated respectively with first and second consecutive wear thresholds (SᵢSᵢ₊₁) satisfy NEᵢ<NEᵢ₊₁, with the wear threshold Sᵢ₊₁ being higher than the wear threshold Sᵢ.

38. The tyre according to claim 34, wherein kᵢ=NEᵢ₊₁/NEᵢ>1 for any value of i ε [1, M], where M is a total number of the wear thresholds and kᵢ is a natural integer.

39. The tyre according to claim 35, wherein kᵢ=NEᵢ₊₁/NEᵢ>1 for any value of i ε [1, M], where M is a total number of the wear thresholds and kᵢ is a natural integer.

40. The tyre according to claim 36, wherein kᵢ=NEᵢ₊₁/NEᵢ>1 for any value of i ε [1, M], where M is a total number of the wear thresholds and kᵢ is a natural integer.

41. The tyre according to claim 37, wherein kᵢ=NEᵢ₊₁/NEᵢ>1 for any value of i ε [1, M], where M is a total number of the wear thresholds and kᵢ is a natural integer.

42. The tyre according to claim 16, wherein each wear indicator associated with a given wear threshold also is associated with a wear threshold above the given wear threshold.

43. The tyre according to claim 17, wherein each wear indicator associated with a given wear threshold also is associated with a wear threshold above the given wear threshold.

44. The tyre according to claim 18, wherein each wear indicator associated with a given wear threshold also is associated with a wear threshold above the given wear threshold.

45. The tyre according to claim 19, wherein each wear indicator associated with a given wear threshold also is associated with a wear threshold above the given wear threshold.
